(19) United States
(12) Patent Application Publication
(10) Pub. No.: US 2006/0182422 A1
(43) Pub. Date: Aug. 17, 2006

(54) Decoding method and apparatus for automotive media-player

(75) Inventor: Juen Tien Peng, Chung Li (TW)

Correspondence Address: HDSL, 4331 STEVENS BATTLE LANE, FAIRFAX, VA, 22033, US

(73) Assignee: Action Electronics Co., Ltd

(21) Appl. No.: 11/045,386

(22) Filed: Jan. 31, 2005

(51) Int. Cl. H04N 7/26

(52) U.S. Cl. 386/109

(57) ABSTRACT

A decoding method and apparatus for an automotive media-player. The data stream filtered by a filter process is divided into a first data stream coded by JPEG, MP3, MPEG, and a second data stream not coded by JPEG, MP3, MPEG. The first data stream is directly inputted into the decoding process for decoding and playing. The second data stream is passed though the transcoding process to be coded again by JPEG, MP3, MPEG, and then entered into the decoding process for decoding and playing. Therefore, not only the data stream coded by JPEG, MP3, and MPEG can be played, but also various data streams other than JPEG, MP3, and MPEG can be played by the automotive media-player.

### BACKGROUND OF THE INVENTION

1. Field of the Invention

The present invention relates to a decoding method and apparatus for an automotive media-player, and more specifically, to a decoding method and apparatus used for an automotive media-player to play the media with various data streams.

2. Description of the Related Art

Conventional automotive stereo components typically utilize a dash-mounted control unit and a remotely-mounted compact disk (CD) changer. The CD's in the automobile are not available on the home stereo equipment.

Portable MP3 players followed the popularization of trunk-mounted CD changers. Various companies market MP3 players (e.g. the Diamond Rio.™ Player). Conventional MP3 players generally include a storage device and a decoder to decode the MP3 (MPEG layer 3) encoded audio data files.

FIG. 1 shows a diagram according to the conventional technology. The data is outputted form the database 2 to be filtered in the filtering process 4. The data is transmitted to the decoding process 6 for decoding. Conventional automotive media-player can only play MPEG1 coded data, MPEG2 coded data, and JEPG coded data. Other coded data, for examples, WORD coded data, EXCEL coded data, POWERPOINT coded data, or PDF coded data, can not be played by the automotive player. However, these data have pretty high practicability. Conventional automotive media-player can not provide the decoding and playing.

In view of this, the present invention provides an improved design to overcome the above-mentioned disadvantages.

### SUMMARY OF THE INVENTION

The present invention provides a decoding method and apparatus for an automotive media-player, which improving the decoding method of an automotive media-player, thereby playing JPEG data stream and other various data streams becomes possible.

According to one preferred embodiment of the present invention, an improved decoding method for automotive player comprises a data stream filtered by a filtering process, thereby the data stream is divided into the data stream coded by JPEG, MP3, and MPEG, and the data not coded by JPEG, MP3, and MPEG. The data stream coded by JPEG, MP3, and MPEG is directly entered into the decoding process for decoding and playing. The data not coded by JPEG, MP3, and MPEG is passed though the transcoding process to be coded again by JPEG, MP3, MPEG, and then entered into the decoding process for decoding and playing. The present invention comprises a system and a decoding apparatus. The database, the filter processor, and a transcoding processor are built in the system. A decoding processor is built in the decoding apparatus. Alternatively, in another preferred embodiment, the database is built in the system. The filter processor, the transcoding processor, and the decoding processor are built in the decoding apparatus.

The objectives of the present invention will become obvious to those of ordinary skill in the art after reading the following detailed description of the preferred embodiment.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram according to the conventional technology;

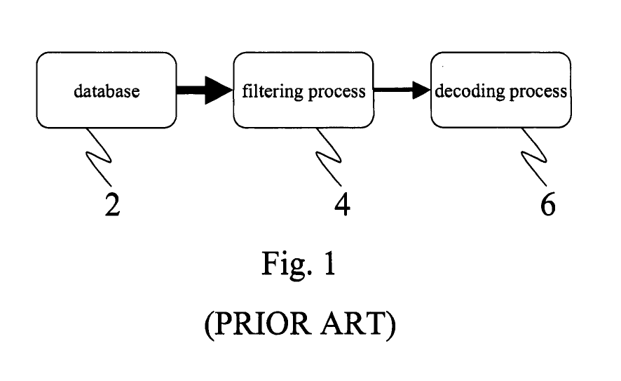

FIG. 2 is a block diagram according to the present invention;

FIG. 3 is a structure diagram according to one embodiment of the present invention; and

FIG. 4 is a structure diagram according to another embodiment of the present invention.

### DETAILED DESCRIPTION OF THE PREFERRED EMBODIMENTS

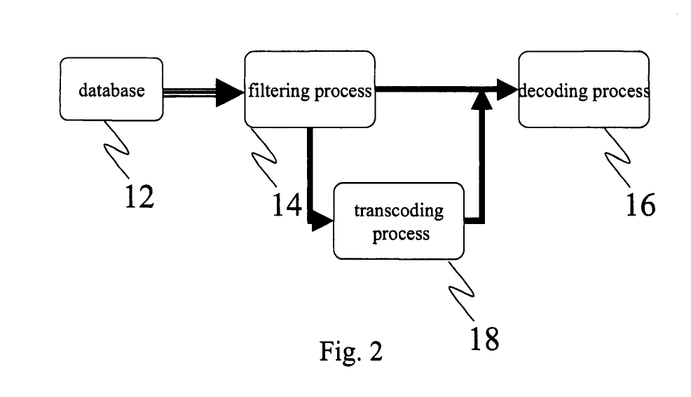

Refer to FIG. 2, a block diagram according to the present invention is shown. Various coded data are outputted from the database 12. These various coded data comprises Joint Photographic Expert Group (JPEG) coded data, WORD coded data, EXCEL coded data, POWERPOINT coded data, PDF coded data and MP3 coded data, which are so-called “data streams”. The source of the data streams is from an external memory card. The external memory card can be read by a device connected via an USB port. The memory card can be CF (Compact Flash) Card, SM (Smart Media) Card, SD (Secured Digital) Card, MMC (Multimedia) Card, and MS (Memory Stick) Card. These data streams are filtered by a filtering process 14, thereby being divided into two classifications: a first data stream, and a second data stream. The first data stream includes those data coded by JPEG, MP3, and MPEG. MPEG coded data stream comprises MPEG1, MPEG2, MPEG3, and MPEG4 coded data. The second data stream includes those data not coded by JPEG, MP3, and MPEG. For examples, the second data stream includes WORD, EXCEL, EXCEL, PDF, or POWERPOINT coded data.

After the original data stream passed though the filtering process 14, the first data stream is directly transmitted to the decoding process 16 for decoding, and the second data stream is passed though the transcoding process 18 to transform the data in the second data stream into the data stream coded by JPEG, MP3 and MPEG, and is then outputted to the decoding process 16 for decoding and playing.

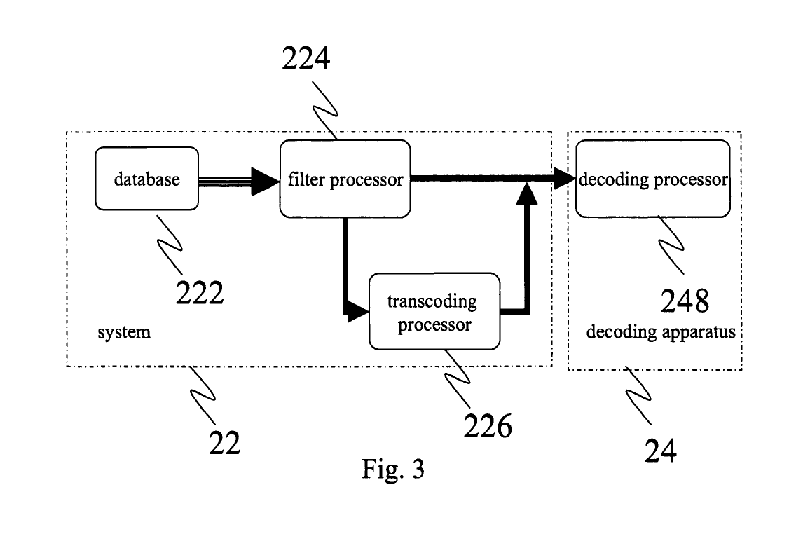

Refer to FIG. 3, an embodiment of the present invention is shown. In this embodiment, a system 22 and a decoding apparatus 24 are provided. The system 22 comprises a built-in database 222, a built-in filter processor 224, and a built-in transcoding processor 226. Various coded data are outputted from the database 222. These various coded data comprises Joint Photographic Expert Group (JPEG) coded data, WORD coded data, EXCEL coded data, POWERPOINT coded data, PDF coded data and MP3 coded data, which are so-called “data streams”. The source of the data streams is from an external memory card. The external memory card is read by a device connected via an USB port. The memory card can be CF (Compact Flash) Card, SM (Smart Media) Card, SD (Secured Digital) Card, MMC (Multimedia) Card, and MS (Memory Stick) Card. These data streams are filtered by the filter processor 224, thereby being divided into two classifications: a first data stream, and a second data stream. The first data stream is coded by JPEG, MP3, and MPEG. MPEG coded data stream comprises MPEG1, MPEG2, MPEG3, and MPEG4 coded data. The second data stream is not coded by JPEG, MP3, and MPEG. For examples, the second data stream includes WORD, EXCEL, PDF, or POWERPOINT coded data. After the original data stream passed though the filter processor 224, the first data stream is directly transmitted to a built-in decoding processor 248 of the decoding apparatus 24 for decoding, and the second data stream is passed though the transcoding processor 226 to transform the data in the second data stream into the data stream coded by JPEG, MP3 and MPEG, and is then outputted to the decoding processor 248 for decoding and playing.

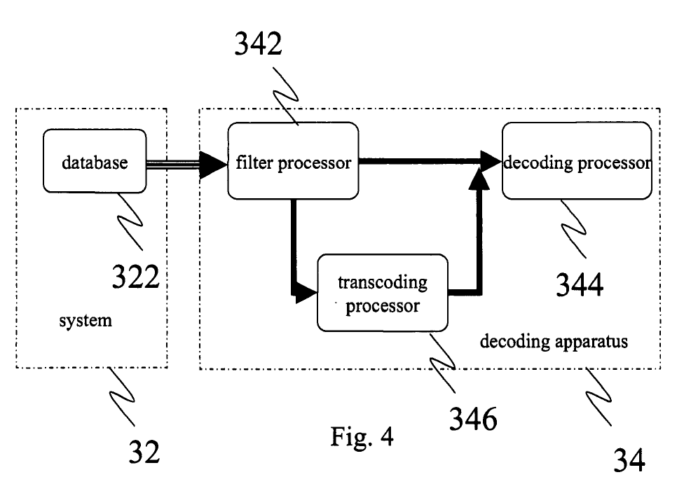

Refer to FIG. 4, another embodiment of the present invention is shown. In this embodiment, a system 32 and a decoding apparatus 34 are provided. The system 32 comprises a built-in database 322. The decoding apparatus 34 comprises a built-in filter processor 342, a built-in transcoding processor 322, and a built-in decoding processor 344. Various coded data are outputted from the database 322. These various coded data comprises Joint Photographic Expert Group (JPEG) coded data, WORD coded data, EXCEL coded data, POWERPOINT coded data, PDF coded data and MP3 coded data, which are so-called “data streams”. The source of the data streams is from an external memory card. The external memory card is read by a device connected via an USB port. The memory card can be CF (Compact Flash) Card, SM (Smart Media) Card, SD (Secured Digital) Card, MMC (Multimedia) Card, and MS (Memory Stick) Card. These data streams are filtered by a filter processor 342, thereby being divided into two classifications: a first data stream, and a second data stream. The first data stream is coded by JPEG, MP3, and MPEG. MPEG coded data stream comprises MPEG1, MPEG2, MPEG3, and MPEG4 coded data. The second data stream is not coded by JPEG, MP3, and MPEG. For examples, the second data stream includes WORD, EXCEL, PDF, or POWERPOINT coded data. After the original data stream passed though the filter process 342, the first data stream is directly transmitted to a built-in decoding processor 344 of the decoding apparatus 34 for decoding, and the second data stream is passed though the transcoding processor 346 to transform the data in the second data stream into the data stream coded by JPEG, MP3 and MPEG, and is then outputted to the decoding processor 344 for decoding and playing.

The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. A decoding method for an automotive media-player, comprising:
providing a data stream for passing though a filtering process to be divided into a first data stream and a second data stream; and
directly executing the first data stream into a decoding apparatus, executing the second data stream to pass though a transcoding process, and then entering into a decoding process to decode.

2. The decoding method of claim 1, wherein the first data stream is selected from the groups consisting of Joint Photographic Expert Group (JPEG), MPEG-1 Audio Layer-3 (MP3), Moving Pictures Experts Group-1 (MPEG-1), Moving Pictures Experts Group-2 (MPEG-2), Moving Pictures Experts Group-3 (MPEG-3), and Moving Pictures Experts Group-4 (MPEG-4) coded data.

3. The decoding method of claim 1, wherein the second data stream is selected from the groups consisting of WORD, EXCEL, PDF and POWERPOINT coded data.

4. The decoding method of claim 1, wherein the data stream is obtained from a database.

5. The decoding method of claim 1, wherein the data stream is obtained from an external memory card.

6. The decoding method of claim 5, wherein the external memory card is read by a device connected via an USB (Universal Serial Bus) port.

7. The decoding method of claim 5, wherein the external memory card is selected from the groups consisting of CF (Compact Flash) Card, SM (Smart Media) Card, SD (Secured Digital) Card, MMC (Multimedia) Card, and MS (Memory Stick) Card.

8. The decoding method of claim 1, wherein the decoding process comprises JPEG decoding process, MP3 decoding process, MPEG1 decoding process, MPEG2 decoding process, MPEG3 decoding process and MPEG4 decoding process.

9. The decoding method of claim 1, wherein the automotive media-player is portable or is fixed on a car.

10. An automotive media-player, comprising:
a system apparatus having a database, a filter processor, and a transcoding processor, for a data stream being divided into a first data stream and a second data stream after the data stream is pass though the filter processor; and
a decoding apparatus having a decoding processor to directly decode the first data stream, and to decode the second data stream after the second data stream passes though the transcoding processor.

11. The automotive media-player of claim 10, wherein the first data stream is selected from the groups consisting of Joint Photographic Expert Group (JPEG), MPEG-1 Audio Layer-3 (MP3), Moving Pictures Experts Group-1 (MPEG-1), Moving Pictures Experts Group-2 (MPEG-2), Moving Pictures Experts Group-3 (MPEG-3), and Moving Pictures Experts Group-4 (MPEG-4) coded data.

12. The automotive media-player of claim 10, wherein the second data stream is selected from the groups consisting of WORD, EXCEL, PDF and POWERPOINT coded data.

13. The automotive media-player of claim 10, wherein the system apparatus further connects with an external memory card.

14. The automotive media-player of claim 13, wherein the external memory card is read by a device connected via an USB (Universal Serial Bus) port.

15. The automotive media-player of claim 13, wherein the external memory card is selected from the groups consisting of CF (Compact Flash) Card, SM (Smart Media) Card, SD (Secured Digital) Card, MMC (Multimedia) Card, and MS (Memory Stick) Card.

16. The automotive media-player of claim 10, wherein the decoding processor comprises JPEG decoding processor, MP3 decoding processor, MPEG1 decoding processor, MPEG2 decoding processor, MPEG3 decoding processor and MPEG4 decoding processor.

17. The automotive media-player of claim 10, wherein the filter processor and the transcoding processor are set in the decoding apparatus.

18. The automotive media-player of claim 10, wherein the automotive player is portable or is fixed on a car.
